(19) United States
(12) Patent Application Publication
(10) Pub. No.: US 2004/0165273 A1
(43) Pub. Date: Aug. 26, 2004

(54) Optical module with optical transmission and diffusion elements

(76) Inventor: Heng Sheng Kuo, Taipei (TW)

Correspondence Address: HENG SHENG KUO, P.O. BOX 26-757, TAIPEI, TW

(21) Appl. No.: 10/371,963

(22) Filed: Feb. 17, 2003

(51) Int. Cl. G02B 5/02; G02B 13/20

(52) U.S. Cl. 359/599

(57) ABSTRACT

An optical module with optical transmission and diffusion elements has a base, an optical transmission element, an optical diffusion element and a light source. The optical transmission element is made of a transparent material and is formed on one surface of the base, with a light-emerging surface separated from the base. The optical diffusion element is closely attached to the light-emerging surface by fusing to form a light-incidence surface directly in contact with the light-emerging surface. The light source is located between the base and the optical transmission element. With the close attachment of the optically transmitting and diffusion elements, the light travels without loss and thus provides enough brightness and homogeneity.

### BACKGROUND OF THE INVENTION

1. Field of the Invention u

The invention relates to an optical module. More particularly, the invention provides an optical module that has optical transmission and diffusion elements closely attached to each other.

2. Description of the Related Art

A liquid crystal display device is widely used in computer equipment and household appliances for several advantages such as a compact size and a low energy consumption. The compact size of the liquid crystal display device is achieved by means of an optical module that is provided with optical transmission and diffusion elements. These optical transmission and diffusion elements effectively transmit the light from a light source to provide brightness and homogeneity on a display panel.

Referring to FIG. 1, a conventional optical module includes a base 70, a light source 71, an optical transmission element 50 and an optical diffusion element 60. The optical transmission element 50 is mounted on a surface of the base 70. The optical transmission element 50 has a light-emerging surface 51. The optical diffusion element 60 has a light-incidence surface 61 above the light-emerging surface 51. The light source 71 is mounted between the base 70 and the optical transmission element 50. An optical reflector 72 is mounted on a side surface of the base 70 close to the light source 71. A liquid crystal panel 73 is mounted on a side of the optical diffusion element 60. The light emitted from the light source 71 is transmitted to the liquid crystal panel 73 through the optical transmission and diffusion elements 50, 60 for image display.

In the above structure of a conventional optical module, the optical diffusion element 60 is sequentially mounted on the optical transmission element 50 and the base 70 or the like. Since the optical transmission and diffusion elements 50, 60 are separately formed, the light-emerging surface 51 and the light-incidence surface 61 cannot perfectly match each other. An irregular air layer 80 often exists between the light-emerging surface 51 and the light-incidence surface 61, causing reduced brightness and homogeneity of light on a display panel.

### SUMMARY OF THE INVENTION

It is therefore a principal object of the invention to provide an optical module that has optical transmission and diffusion elements closely attached to prevent the presence of impurities creating an interface therebetween, so that the optical module can provide light of sufficient brightness and homogeneity.

To accomplish the above and other objectives, the invention provides an optical module including a base, an optical transmission element, an optical diffusion element and a light source. The optical transmission element is made of a transparent material and formed on one surface of the base, with a light-emerging surface separated from the base. The optical diffusion element is closely attached to the light-emerging surface by fusing to form a light-incidence surface directly in contact with the light-emerging surface. The light source is located between the base and the optical transmission element.

The light-incidence surface of the optical diffusion element thus is closely attached to the light-emerging surface of the optical transmission element without any intermediary medium such as air interfacing there between. The light emitted from the light source therefore can travel through the optical transmission and diffusion elements without loss, and thus provides sufficient brightness and homogeneity on the liquid crystal panel.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of a conventional optical module;

FIG. 2 is an enlarged view of part A in FIG. 1;

FIG. 3 is a perspective view of an optical module according to one preferred embodiment of the invention;

FIG. 4 is a cross-sectional view of an optical module according to one preferred embodiment of the invention;

FIG. 4A is an enlarged view of part A in FIG. 4;

FIG. 5 is a perspective view of an optical transmission element, an upper mold and a lower mold according to one embodiment of the invention;

FIG. 6 is a perspective view of an optical transmission element placed between an upper mold and a lower mold according to one embodiment of the invention; and

FIG. 7 is a perspective view illustrating the formation of an optical diffusion element and an optical transmission element according to one embodiment of the invention.

### DETAILED DESCRIPTION OF THE EMBODIMENTS

Wherever possible in the following description, like reference numerals will refer to like elements and parts unless otherwise illustrated.

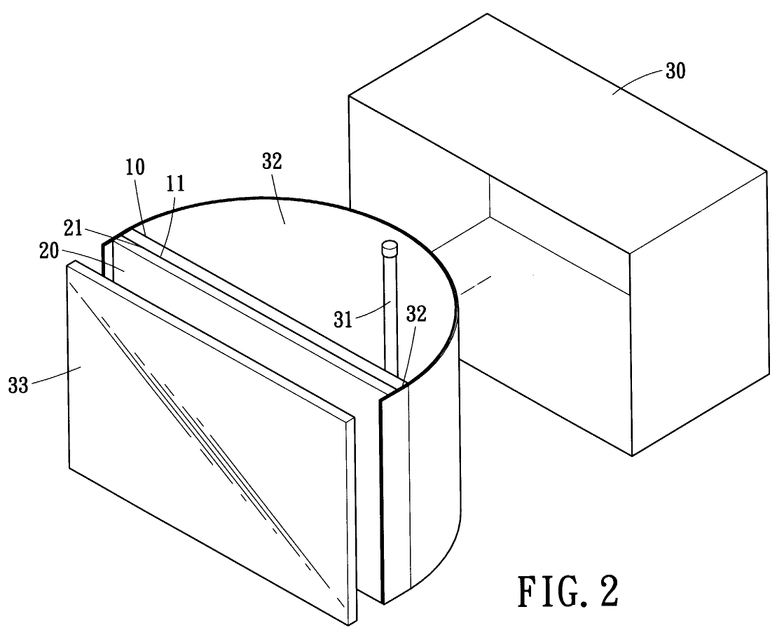

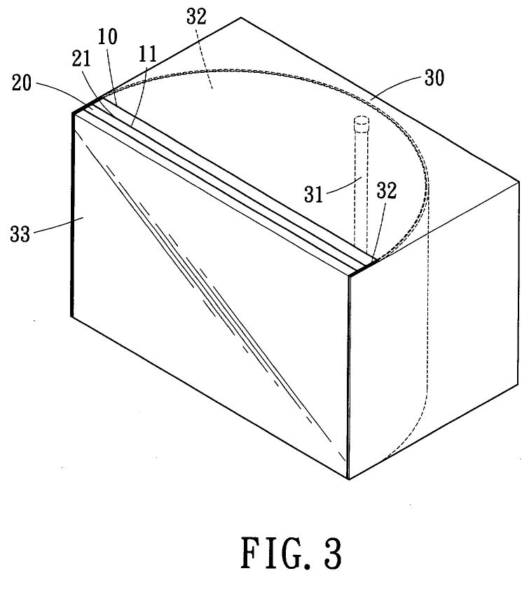

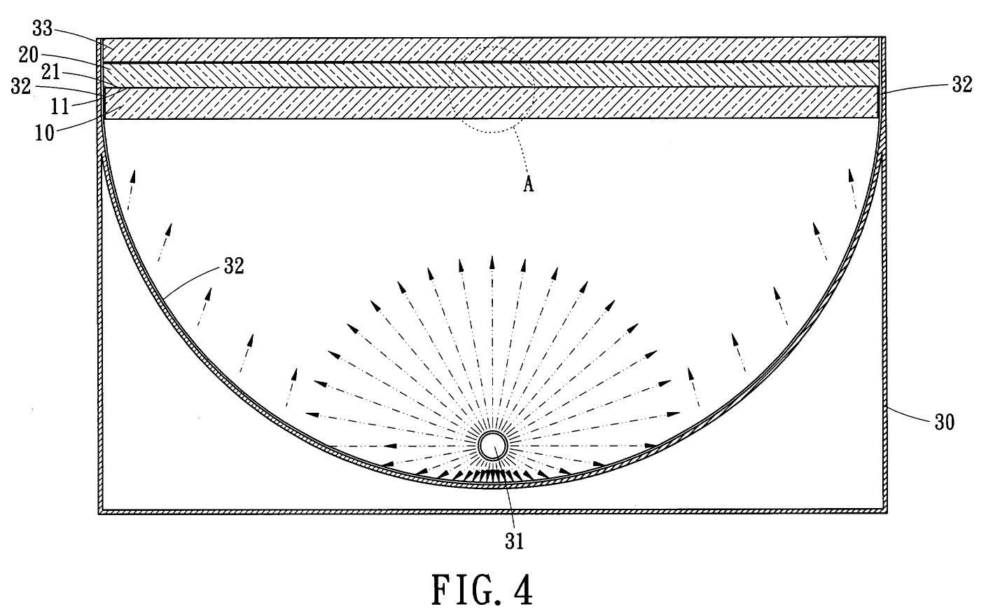

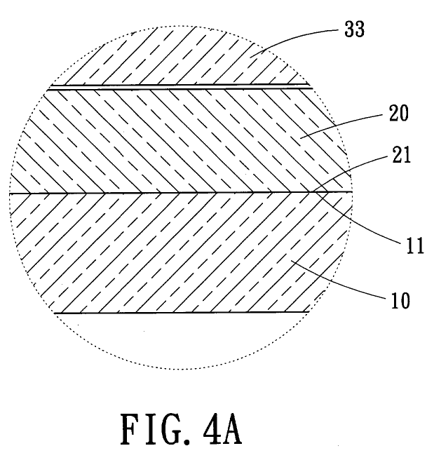

Referring to FIG. 2 through FIG. 4, the invention provides an optical module with optical transmission and diffusion elements. The optical module includes a base 30, an optical transmission element 10, an optical diffusion element 20 and a light source 31.

The optical transmission element 10 is made of a transparent material and is formed on one surface of the base 30. The optical transmission element 10 has a light-emerging surface 11 separated from the base 30.

The optical diffusion element 20 is closely attached on the light-emerging surface 11 by fusing. A first surface of the optical diffusion element 20 directly contacting the light-emerging surface 11 is designated light-incidence surface 21. The light-emerging surface 11 and the light-incidence surface 21 are clean, and include no impurities therebetween. On a second surface of the optical diffusion element 20 opposite the light-incidence surface 21 is attached a liquid crystal panel 33.

The light source 31 is formed between the base 30 and the optical transmission element 10. An optically reflecting element 32 is formed on the base 30, facing and close to the light source 31. On a side surface of the optical transmission element 10 is further formed another optically reflecting element 32. A portion of the surface of the optical transmission element 10 close to the light source 31 can be optionally patterned.

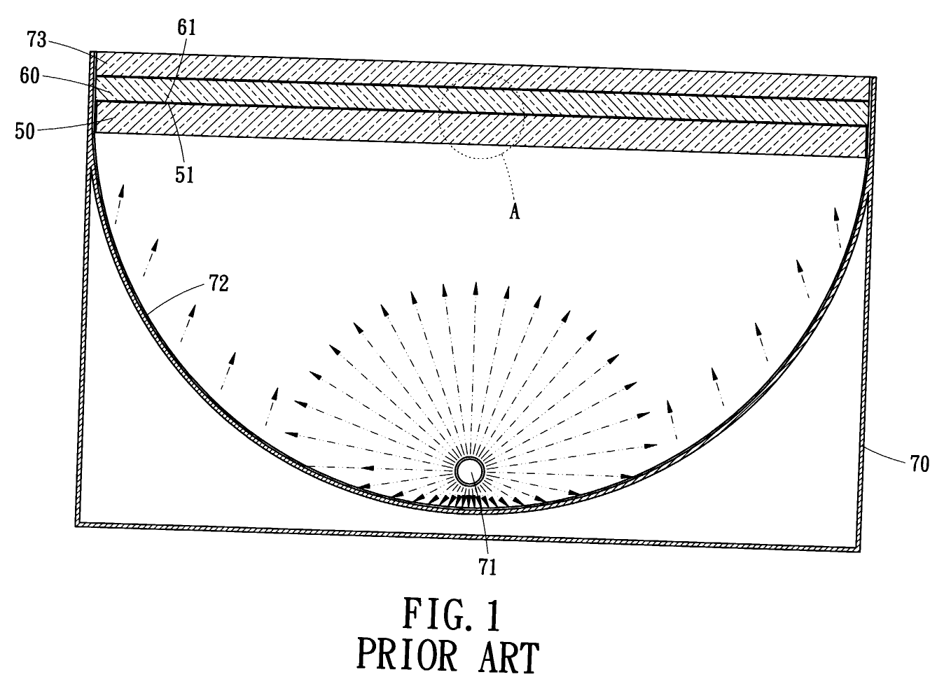

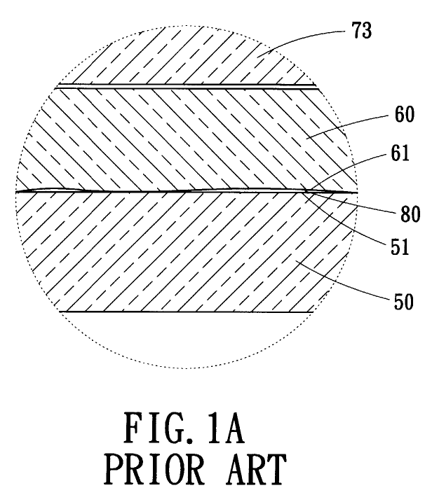

The interface between the optical transmission element 10 and the optical diffusion element 20 is without intermediary medium so that light emitted from the light source 31 smoothly travels through the optical transmission and diffusion elements 10, 20. Since the optical module of the invention lacks irregular air layer 80 (as shown in FIG. 1A) between the light-emerging surface 11 and the light-incidence surface 21, the light travels through the liquid crystal panel 33 without loss. Therefore, the light reaching the panel provides sufficient brightness and homogeneity.

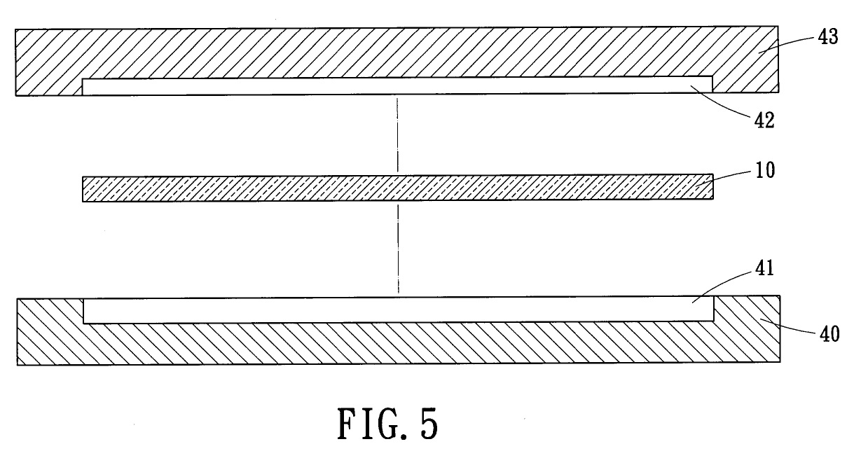

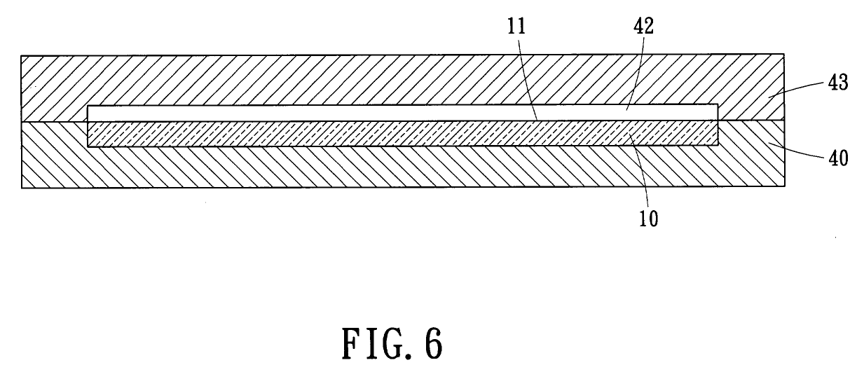

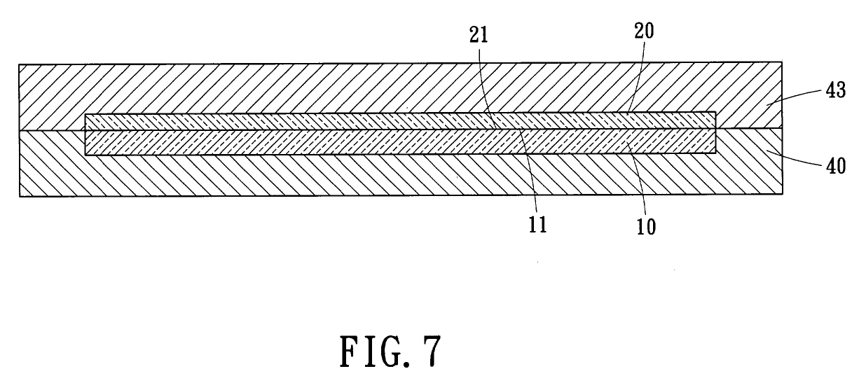

Reference now is made to FIG. 5 through FIG. 7, for a detailed description of a manufacturing process of the optical module according to one embodiment of the invention. The optical transmission element 10 is provided and placed in a slot 41 of a lower mold 40 and clipped by an upper mold 43, with a gap 42 between the light-emerging surface 11 of the optical transmission element 10 and the upper mold 43. A fusing material is injected into the gap 42 to form the optical diffusion element 20 directly on the optical transmission element 10. Therefore, the light-incidence surface 21 of the optical diffusion element 20 is in close contact with the light-emerging surface 11 of the optical transmission element 10.

As described above, the optical module of the invention provides the following advantages.

The optical transmission element has been formed before being placed in the lower mold. The gap between the upper mold and the optical transmission element is injected with a fusion stock to form the optical transmission element. Therefore, the light-incidence surface of the optical diffusion element is closely attached to the light-emerging surface of the optical transmission element, without any intermediary medium such as air interfacing there between. The light emitted from the light source therefore can travel through the optical transmission and diffusion elements without loss, and thus provides sufficient brightness and homogeneity on the liquid crystal panel.

Those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An optical module with optical transmission and diffusion elements, the optical module comprising:
a base;
an optical transmission element, made of a transparent material and formed on one surface of the base, wherein the optical transmission element has a light-emerging surface separated from the base;
an optical diffusion element, closely attached on the light-emerging surface by fusing to form a light-incidence surface directly in contact with the light-emerging surface; and
a light source, located between the base and the optical transmission element.

2. The optical module of claim 1, wherein the light-emerging surface of the optical transmission element and light-incidence surface are clean and do not include impurities.

3. The optical module of claim 1, wherein an optically reflecting element is formed on the base, facing and close to the light source.

4. The optical module of claim 1, wherein a portion of the surface of the optical transmission element close to the light source is further patterned.

5. The optical module of claim 1, wherein the optical diffusion element is attached on the optical transmission element by injecting a fusion material between the optical transmission element and an upper mold after the optical transmission element has been placed in a lower mold, thereby forming the light-incidence surface in close contact with the light-emerging surface of the optical transmission element.
